(19) United States
(12) Patent Application Publication
(10) Pub. No.: US 2011/0141279 A1
(43) Pub. Date: Jun. 16, 2011

(54) SURVEILLANCE CAMERA SYSTEM AND METHOD

(75) Inventor: Chen-Chin Cheng, Hsinchu City (TW)

(73) Assignee: INDUSTRIAL TECHNOLOGY RESEARCH INSTITUTE, Hsinchu (TW)

(21) Appl. No.: 12/763,194

(22) Filed: Apr. 19, 2010

(30) Foreign Application Priority Data
Dec. 10, 2009 (TW) 98142329

(51) Int. Cl. H04N 5/232; H04N 7/18

(52) U.S. Cl. 348/143; 348/345; 348/E07.085; 348/E05.045

(57) ABSTRACT

A surveillance camera system including an optical imaging apparatus, a first reflective device and a second reflective device is provided. The optical imaging apparatus is capable of switching between a first magnification level and a second magnification level. The first reflection device is disposed at a position relative to the optical imaging apparatus for guiding a first field of view into the optical imaging apparatus, wherein the first reflective device has an opening region. The second reflective device is disposed within the opening region of the first reflection device for guiding a second field of view into the optical imaging apparatus. The second reflection device can have a relative motion relative to the first reflection device.

### CROSS-REFERENCE TO RELATED APPLICATION

This application claims the priority benefit of Taiwan application serial no. 98142329, filed on Dec. 10, 2009. The entirety of the above-mentioned patent application is hereby incorporated by reference herein and made a part of specification.

### BACKGROUND OF THE INVENTION

1. Technical Field

The disclosure relates to a surveillance camera system and a method thereof.

2. Description of Related Art

An aerial surveillance camera system has a plurality of applications in military use and commercial use, and taking aerial photographs of the ground is one of the most commonly used applications.

It takes relatively long time to change a focal length of a present surveillance camera system. At a wide-angle end, it is suitable for monitoring multiple targets in a large area, though it is not suitable for capturing a clear amplified image of target for identification and recognition. Conversely, at a telephoto end, it is suitable for capturing the close-up image of target for identification and recognition, though it is not suitable for monitoring multiple targets in the large area. Generally, only the objects located near the center of field of view (FOV) of the wide-angle end can be captured through the telephoto end, though objects outside the central part of FOV of the wide-angle end cannot be immediately observed by the telephoto end, so that the whole imaging system has to be pan-tilted to change a FOV range of the telephoto end. However, a driving speed of the whole imaging system is quite slow. Since the aerial surveillance camera system has a high motion speed relative to the ground, the time for the object appearing in the FOV range is relatively short, so that a rapid pan-tilt is required. To achieve the rapid pan-tilt, in a conventional technique, the pan-tilt is implemented by driving an optical component, to replace a driving method of pan-tilting on the whole imaging system.

FIG. 1 is a structural schematic diagram illustrating a conventional pan-tilt surveillance camera system. Referring to FIG. 1, in the conventional pan-tilt surveillance camera system, two-axis rotations can be performed relative to a stationary point 54, and a gimbal is used to drive a reflector 52 to change an imaging FOV of the ground, to reflect the FOV to an imaging system 50. The two-axis rotations refer to that rotations along two axes are allowed, for example, rotations along two directions of horizontal azimuth and elevation. However, in such conventional method, although the reflector 52 is driven to replace driving the whole imaging system, switches between the telephoto end and the wide-angle end are all implemented through the reflector 52, so that usage efficiency thereof is required to be further enhanced.

### SUMMARY

The disclosure is directed to a surveillance camera system and a method thereof, in which images of a wide-angle end and a telephoto end are simultaneously taken into consideration, to facilitate obtaining clear surveillance images of two different field of views.

The disclosure provides a surveillance camera system including an optical imaging apparatus, a first reflection device and a second reflection device. The optical imaging apparatus is capable of switching between a first magnification level and a second magnification level. The first reflection device is disposed at a position relative to the optical imaging apparatus for guiding a first field of view into the optical imaging apparatus, wherein the first reflection device has an opening region. The second reflection device is disposed within the opening region of the first reflection device for guiding a second field of view into the optical imaging apparatus. The second reflection device is capable of performing a relative motion relative to the first reflection device.

The disclosure provides a surveillance camera method. In the method, an optical imaging apparatus is provided, wherein the optical imaging apparatus is capable of switching between a first magnification level and a second magnification level. A first reflection device is disposed at a position relative to the optical imaging apparatus for guiding a first field of view into the optical imaging apparatus, wherein the first reflection device has an opening region. A second reflection device is disposed within the opening region of the first reflection device for guiding a second field of view into the optical imaging apparatus, wherein the second reflection device is capable of performing a motion relative to the first reflection device. During the relative motion, the second reflection device is rotated to change an angle between the second reflection device and the optical imaging apparatus. The optical imaging apparatus is switched to one of the first magnification level and the second magnification level to perform imaging.

In order to make the aforementioned and other features of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a structural schematic diagram illustrating a conventional pan-tilt surveillance camera system.

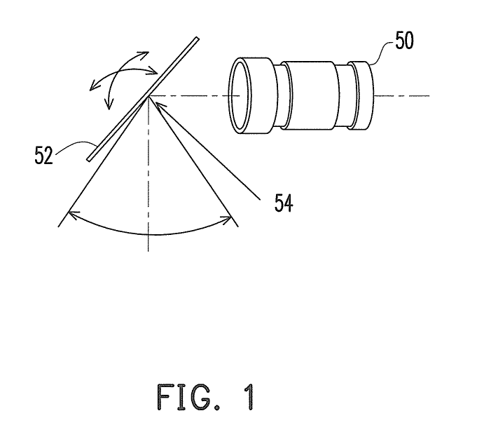

FIG. 2A and FIG. 2B are structural schematic diagrams illustrating a surveillance camera system according to an embodiment of the disclosure.

FIG. 3 is a schematic diagram illustrating an operation mechanism between a first reflection device 102 and a second reflection device 104 according to an embodiment of the disclosure.

FIG. 4 is a schematic diagram illustrating an operation mechanism between a first reflection device 102 and a second reflection device 104 according to an embodiment of the disclosure.

FIG. 5 is a schematic diagram illustrating an operation mechanism between a first reflection device 102 and a second reflection device 104 according to an embodiment of the disclosure.

FIG. 6 is a structural schematic diagram illustrating a surveillance camera system according to an embodiment of the disclosure.

FIGS. 7-10 are schematic diagrams illustrating surveillance operations of a surveillance camera system according to an embodiment of the disclosure.

FIG. 11 is a structural schematic diagram illustrating an optical switch device 250 according to an embodiment of the disclosure.

FIG. 12 is a structural schematic diagram illustrating an optical switch device 250 according to an embodiment of the disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

The disclosure provides a surveillance camera system and a method thereof, in which a fast focal length switching mechanism and a pan-tilt mechanism for achieving surveillance in a large area and obtaining clear close-up images in a small region are simultaneously taken into consideration. In case of a real-time surveillance, a field of view of a telephoto end can be changed, and images within the field of view of a wide-angle end can also be updated immediately, to prevent a surveillance dead region.

A plurality of embodiments is provided below for describing the disclosure, though the disclosure is not limited to the provided embodiments, and the provided embodiments can also be suitably combined.

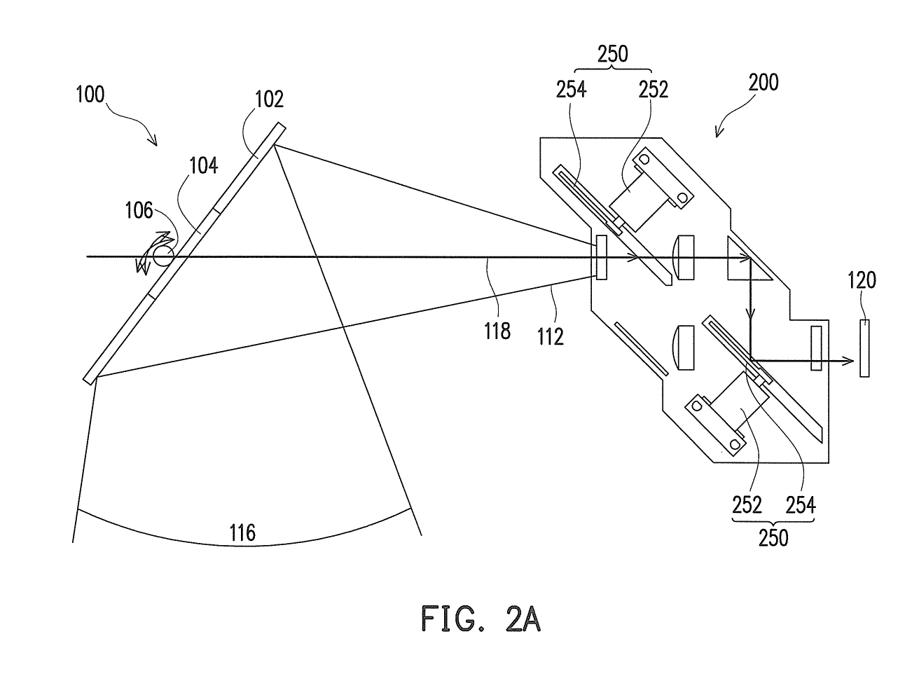

FIG. 2A and FIG. 2B are structural schematic diagrams illustrating a surveillance camera system according to an embodiment of the disclosure. Referring to FIG. 2A, the surveillance camera system can include a reflection apparatus 100 and an optical imaging apparatus 200. The optical imaging apparatus 200 is capable of switching between a first magnification level and a second magnification level, which corresponds to zooming or change between a wide-angle end and a telephoto end in an example. An embodiment of the optical imaging apparatus 200 is provided below for describing a function thereof. The optical imaging apparatus 200 of FIG. 2A is switched to the first magnification level, for example. The surveillance camera system of the present embodiment is disposed on an aircraft for monitoring the ground, though the disclosure is not limited thereto.

The optical imaging apparatus 200 is also an optical apparatus used for capturing images. Regarding the function of surveillance, only a function of zooming between the telephoto end and the wide-angle end is required. However, since the aerial surveillance camera system moves fast, and can obtain a specific target in the surveillance region or a close-up image of a local region through the telephoto end at any moment, a rapid zooming between the telephoto end and the wide-angle end is required. The optical imaging apparatus 200 can include two optical switching devices 250 in an optional design. Depending on the switching status of the optical switching devices 250, the optical imaging apparatus 200 can switch to a desired one of two optical paths. One of the optical paths has the first magnification level and corresponds to a wide-angle end imaging, as that shown in FIG. 2A, and another optical path has the second magnification level and corresponds to a telephoto end imaging, as that shown in FIG. 2B.

Referring to FIG. 2A, an optical axis path 118 of the optical imaging apparatus 200 is, for example, in a state corresponding to a first optical path, which is, for example, a wide-angle end optical path for capturing a FOV 116. A light beam 112 enters the optical imaging apparatus 200 from the left, and after passing through a lens, the light beam 112 directly passes through a first ON/OFF optical switching device 250. Such optical switching device 250 can include a rotation driving unit 252 for rotating a fan sheet 254. When the optical switching device 250 is in an OFF state, the light beam 112 directly passes there through to reach a reflection device, and is further reflected to a fan sheet 254 of another optical switching device 250. The fan sheet 254 of such optical switch device 250 is in an ON state, so that the light beam 112 is reflected to an image sensing device 120 for imaging and video recording.

Referring to FIG. 2B, compared to the ON/OFF states of the two optical switch devices 250 of FIG. 2A, the front optical switch device 250 is in the ON state, and the rear optical switch device 250 is in the OFF state, which can form a telephoto end optical path for capturing another FOV 114, and a light beam 110 still enters the optical imaging apparatus 200 according to the optical axis path 118. However, the optical imaging apparatus 200 can be quickly switched to the corresponding telephoto optical path. The optical imaging apparatus 200 can be switched between the telephoto optical path and the wide-angle optical path according to an actual demand.

In coordination with the optical patch switch operations of the optical imaging apparatus 200, a structure and a mechanism of the reflection apparatus 100 are described below. The reflection apparatus 100 is used to guide the FOVs on the ground to the optical imaging apparatus 200 for imaging. The reflection apparatus 100 in an example is implemented by plane mirrors. Since the optical imaging apparatus 200 is switched between the two optical paths, the reflection apparatus 100 can be designed to include a first reflection device 102 and a second reflection device 104. The first reflection device 102 is disposed at a position relative to the optical imaging apparatus 200 for guiding the first FOV 116 into the optical imaging apparatus 200. Taking an applicable design as an example, the position of the first reflection device 102 can be fixed, and an angle is formed between a reflection plane thereof and the optical axis of the optical imaging apparatus 200. The angle can be 45 degrees or in a range of 30-60 degrees. However, the position of the first reflection device 102 can also be non-fixed. The position can also be adjusted according to an actual demand, though a manner as known by those with ordinary skill in the art. However, a necessary rotation mechanical structure has to be configured.

The first reflection device 102 is used for capturing the FOV of the wide-angle end, and a shape and a size thereof are conformed to an imaging range of the wide-angle optical path of the optical imaging apparatus shown in FIG. 2A. The first reflection device 102 has an opening region located on the optical path, which can contain the second reflection device 104.

To simultaneously capture the FOV of the telephoto end, the second reflection device 104 is used to guide the second FOV 114 into the optical imaging apparatus 200. The second reflection device 104 is disposed within the opening region of the first reflection device 102. The second reflection device 104 is capable of performing a motion relative to the first reflection device 102. For example, the second reflection device 104 can perform two-axis rotations through a pan-tilt device 106. Therefore, regarding an image of the wide-angle FOV, the second reflection device 104 can be used to capture a magnified FOV of a desired specific region within the wide-angle FOV through a telephoto end zooming effect.

To enable the second reflection device 104 for rotating within the opening region of the first reflection device 102, a shape and a size of the second reflection device 104 are conformed to that of the opening region of the first reflection device 102, and conformed to the imaging range of the telephoto end optical path of the optical imaging apparatus 200.

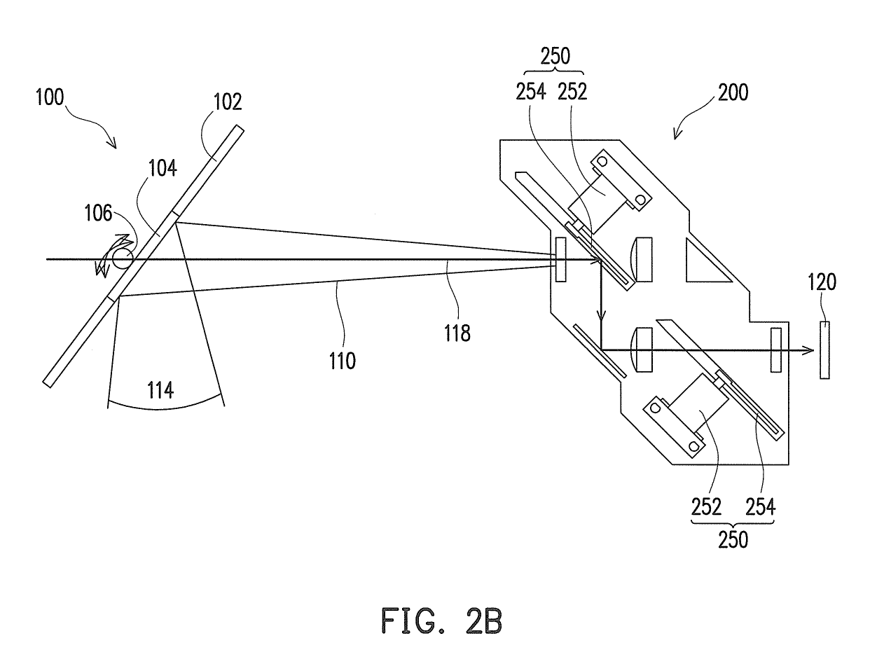

FIG. 3 is a schematic diagram illustrating an operation mechanism between the first reflection device 102 and the second reflection device 104 according to an embodiment of the disclosure. Referring to FIG. 3, the first reflection device 102 is taken as a reference position, and the second reflection device 104 can perform rotations within the opening region, which can be the two-axis rotation.

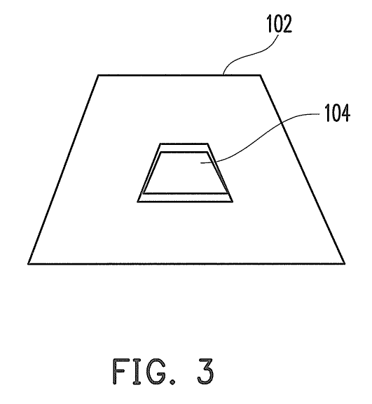

FIG. 4 is a schematic diagram illustrating an operation mechanism between the first reflection device 102 and the second reflection device 104 according to an embodiment of the disclosure. Referring to FIG. 4, the second reflection device 104 is driven to rotate by the pan-tilt device 106, so that a telephoto end image of a region within the FOV 116 of the first reflection device 102 that requires close-up images can be obtained in coordination with the optical path switch of the optical imaging apparatus 200.

Generally, when the optical imaging apparatus 200 is switched to the wide-angle end optical path, the reflection plane of the second reflection device 104 is conformed to the reflection plane of the first reflection device 102 to foil a single reflection plane. Although there is a gap between an edge of the opening region and the second reflection device 104 located in the opening region of the first reflection device 102, which may cause a corresponding image gap noise, an actual surveillance effect is still acceptable.

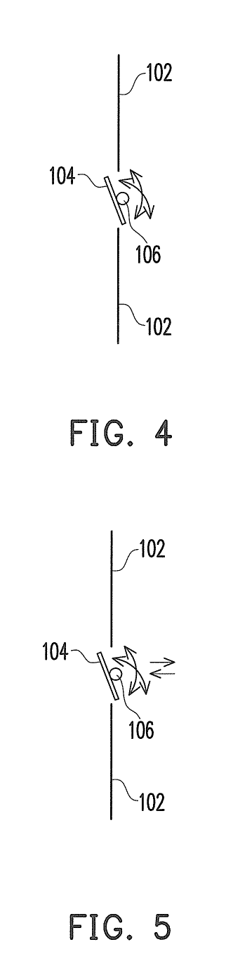

FIG. 5 is a schematic diagram illustrating an operation mechanism between the first reflection device 102 and the second reflection device 104 according to an embodiment of the disclosure. Referring to FIG. 5, the operation mechanism of FIG. 5 is similar to that of FIG. 4, though one motion degree of freedom (DOF) is increased. Since after the second reflection device 104 is driven by the pan-tilt device 106 to rotate, a part of the light beam from the surveillance region is blocked by the first reflection device 102, the second reflection device 104 can be moved back and forth along the optical axis to eliminate the problem of light beam blocking.

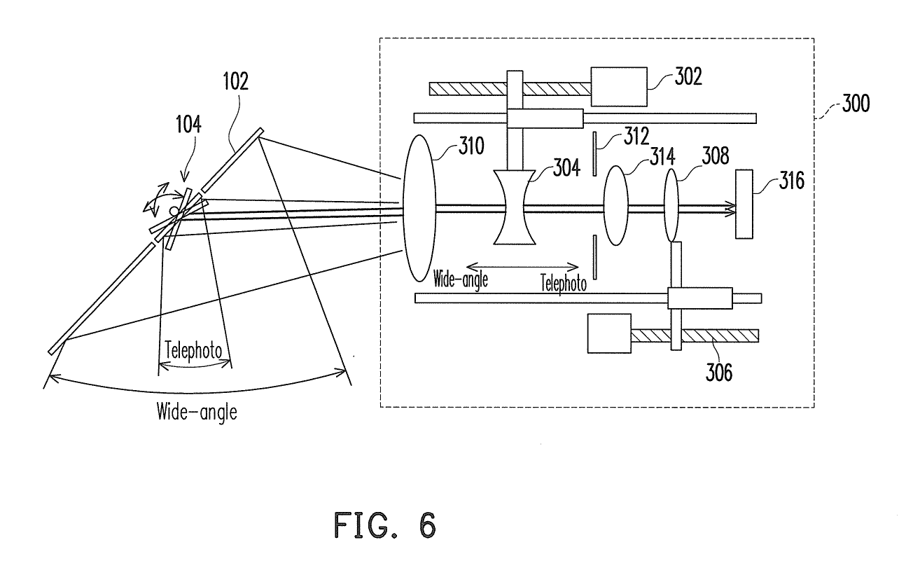

However, the aforementioned optical imaging apparatus 200 is not the only option. FIG. 6 is a schematic diagram illustrating a surveillance camera system according to an embodiment of the disclosure. Referring to FIG. 6, the aforementioned optical imaging apparatus 200 can be replaced by an optical imaging apparatus 300. Regarding a zooming mechanism of the optical imaging apparatus 300, one or two one-dimensional motion driving devices 302 and 306 are used to drive lenses 304 and 308 to change positions thereof on the optical axis. Moreover, the other lenses, such as lenses 310 and 314, have fixed positions. In this way, varying magnification levels between the wide-angle end and the telephoto end of the optical imaging apparatus 300 can be implemented. The second reflection device 104 can perform the two-axis rotations. The first reflection device 102 is used for the imaging operation of the wide-angle end, and is generally fixed to tilt 45 degrees relative to the optical axis of the optical imaging apparatus 300. However, if necessary, the first reflection device 102 can be designed with a rotation function. In addition, the tilt angle can also be in a range of 30-60 degrees.

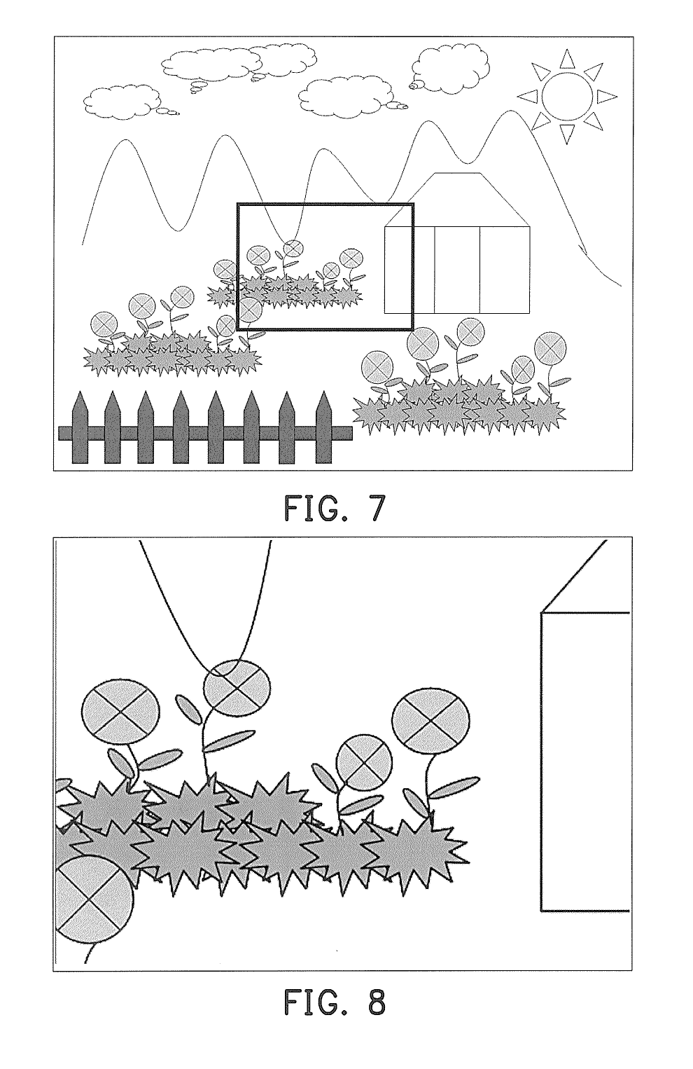

An actual operation effect of the surveillance camera system is described below. FIGS. 7-10 are schematic diagrams illustrating surveillance operations of the surveillance camera system according to an embodiment of the disclosure. Referring to FIG. 7, the large area image is captured based on the wide-angle end magnification level of the surveillance camera system 200, and covers a large FOV, which is an image reflected by the first reflective device 102 and the second reflective device 104. The reflection planes of the first reflection device 102 and the second reflection device 104 are coplanar. The optical imaging apparatus 200 is switched to the wide-angle optical path. Referring to FIG. 8, if the first reflective device and the second reflective device remain coplanar and the optical imaging apparatus 200 is switched to the telephoto optical path, a close-up image of the central part of FIG. 7 is captured.

Referring to FIG. 9, when a dotted line framed small region in the surveillance range of the wide-angle end is required to be monitored in detail, the second reflection device 104 is rotated to the corresponding region, and the optical imaging apparatus 200 is still in the wide-angle end optical path, the dotted line small framed region will also be shown in the central part of wide-angle FOV. If the optical imaging apparatus 200 is switched to telephoto optical path, a close-up image of the dotted line small framed will be captured as shown in FIG. 10.

In the surveillance camera system of the present embodiment, a fast focal length switching mechanism and a pan-tilt mechanism for achieving a large area surveillance and obtaining clear close-up images are simultaneously taken into consideration. The second reflection device 104 of the reflection apparatus 100 is driven by the pan-tilt device 106 to select a small region, to obtain a clear close-up image in coordination with the optical path switch of the optical imaging apparatus 200.

The optical switch devices 250 shown in FIG. 2A and FIG. 2B can be quickly switched according to a rotation approach.

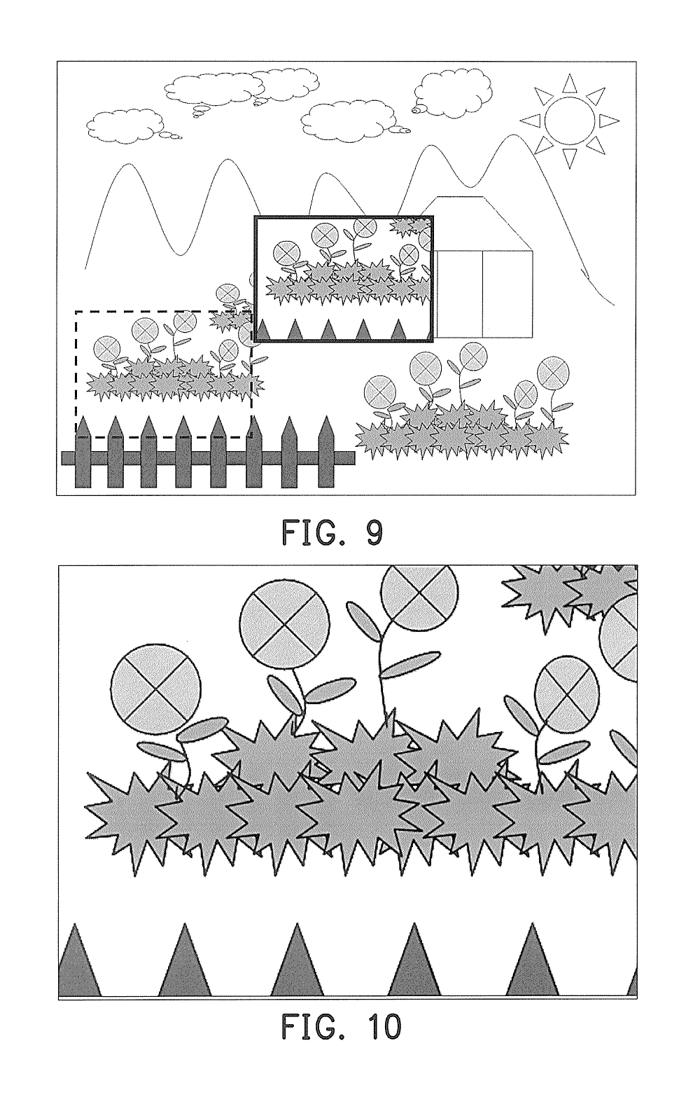

FIG. 11 is a structural schematic diagram illustrating the optical switch device 250 according to an embodiment of the disclosure. Referring to FIG. 11, in the optical switch device 250, the fan sheet 254 is driven to rotate by the rotation driving unit 252. A surface of the fan sheet 254 is a reflection plane 256. When the fan sheet 254 is in the OFF state, an incident light is not reflected by the fan sheet 254. When the fan sheet 254 is in the ON state, the incident light is reflected by the fan sheet 254, and a direction of the optical path is changed to achieve the switching effect.

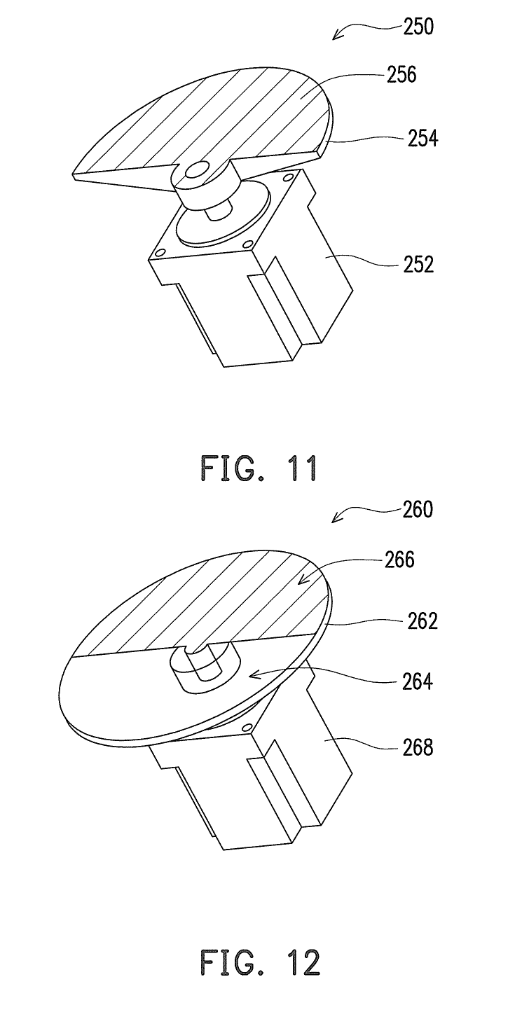

FIG. 12 is a structural schematic diagram illustrating the optical switch device 250 according to an embodiment of the disclosure. Referring to FIG. 12, the switching mechanism of another optical switch device 260 is similar to that of the optical switching device 250 of FIG. 11, though the fan sheet 254 is changed to a transparent round plate 262, and the transparent round plate 262 is driven to rotate by a rotation driving unit 268. A surface of the round plate 262 includes a reflection region 266 and a transparent region 264. Since the round plate 262 is balanced during rotation, a vibration caused by the rotation can be reduced.

Since the optical imaging apparatus 200 has the switching function, if the switching operation is performed in a fixed frequency, in coordination with a motion control of the second reflection device 104, two sets of video images can be obtained, so that an automatic surveillance effect is enhanced.

It will be apparent to those skilled in the art that various modifications and variations can be made to the structure of the disclosure without departing from the scope or spirit of the disclosure. In view of the foregoing, it is intended that the disclosure cover modifications and variations of this invention provided they fall within the scope of the following claims and their equivalents.

What is claimed is:

1. A surveillance camera system, comprising:
an optical imaging apparatus, capable of switching between a first magnification level and a second magnification level;
a first reflective device, disposed at a position relative to the optical imaging apparatus, for guiding a first field of view into the optical imaging apparatus, wherein the first reflective device has an opening region; and
a second reflective device, disposed within the opening region of the first reflection device, for guiding a second field of view into the optical imaging apparatus, wherein the second reflective device is capable of performing a relative motion relative to the first reflective device.

2. The surveillance camera system as claimed in claim 1, wherein the second reflective device comprises a pan-tilt device capable of performing two-axis rotations relative to the first reflective device.

3. The surveillance camera system as claimed in claim 2, wherein the relative motion of the second reflective device relative to the first reflective device comprises a translation motion.

4. The surveillance camera system as claimed in claim 1, wherein a first angle is formed between a reflective plane of the first reflective device and an incident optical axis of the optical imaging apparatus.

5. The surveillance camera system as claimed in claim 4, wherein the first angle is in a range of 30-60 degrees.

6. The surveillance camera system as claimed in claim 4, wherein a reflection plane of the second reflective device is capable of performing two-axis rotations relative to an incident optical axis of the optical imaging apparatus.

7. The surveillance camera system as claimed in claim 1, wherein imaging is implemented through the first reflective device based on the first magnification level of the optical imaging apparatus.

8. The surveillance camera system as claimed in claim 1, wherein imaging is implemented through the second reflective device based on the second magnification level of the optical imaging apparatus.

9. The surveillance camera system as claimed in claim 1, wherein the second reflective device is rotated to set both reflection planes of the first reflective device and the second reflective device in parallel, and the second reflective device with the first reflective device forms a common reflection plane for simultaneously reflecting the first field of view and the second field of view to the optical imaging apparatus.

10. The surveillance camera system as claimed in claim 9, wherein the second reflective device is capable of performing a translation motion to compensate a phenomenon that a part of light beam from a monitored region is blocked by the first reflection device after the second reflection device is rotated.

11. The surveillance camera system as claimed in claim 1, wherein the first magnification level is a wide-angle focal length, and the second magnification level is a telephoto focal length.

12. The surveillance camera system as claimed in claim 1, wherein a shape of the second reflection device is similar to a shape of the opening region of the first reflection device, and the second reflection device is capable of rotating within the opening region.

13. The surveillance camera system as claimed in claim 1, wherein a size of the second reflective device corresponds to a viewing angle range of the second magnification level of the optical imaging apparatus.

14. The surveillance camera system as claimed in claim 1, wherein the optical imaging apparatus is switched between the first magnification level and the second magnification level in a fixed frequency, and the second reflective device is also rotated for two angles according to the fixed frequency, to obtain two sets of video surveillance images.

15. The surveillance camera system as claimed in claim 14, wherein the reflection plane of the second reflection device is rotated at one of the two angles to be conformal to the reflection plane of the first reflective device.

16. A surveillance camera method, comprising:
providing an optical imaging apparatus capable of switching between a first magnification level and a second magnification level;
disposing a first reflective device at a position relative to the optical imaging apparatus for guiding a first field of view into the optical imaging apparatus, wherein the first reflective device has an opening region;
disposing a second reflective device within the opening region of the first reflection device for guiding a second field of view into the optical imaging apparatus, wherein the second reflective device is capable of performing a relative motion relative to the first reflective device;
rotating the second reflective device to change an angle between the second reflective device and the optical imaging apparatus during the relative motion; and
switching the optical imaging apparatus to one of the first magnification level and the second magnification level to perform imaging.

17. The surveillance camera method as claimed in claim 16, wherein the motion of rotating the second reflection device comprises performing two-axis rotations relative to an optical axis of the optical imaging apparatus.

18. The surveillance camera method as claimed in claim 17, wherein the relative motion of the second reflective device comprises translating the second reflection device to compensate a phenomenon that a part of light beam from a surveillance region is blocked by the first reflective device after the second reflective device is rotated.

19. The surveillance camera method as claimed in claim 17, wherein a first angle is formed between a reflection plane of the first reflective device and an incident optical axis of the optical imaging apparatus.

20. The surveillance camera method as claimed in claim 19, wherein the first angle is fixed to about 45 degrees.

21. The surveillance camera method as claimed in claim 20, wherein the motion of rotating the second reflection device comprises rotating the second reflection device to change a second angle between a reflection plane of the second reflective device and the incident optical axis of the optical imaging device.

22. The surveillance camera method as claimed in claim 20, wherein when the first field of view is captured through the first reflective device, the optical imaging device is switched to the first magnification level.

23. The surveillance camera method as claimed in claim 20, wherein when the second field of view is captured through the second reflective device, the optical imaging device is switched to the second magnification level.

24. The surveillance camera method as claimed in claim 20, wherein the motion of rotating the second reflection device comprises rotating the second reflective device to be set in parallel with the first reflective device, so that the second reflection device and the first reflection device form a common reflection plane for simultaneously reflecting the first field of view and the second field of view to the optical imaging apparatus.

25. The surveillance camera method as claimed in claim 20, further comprising translating the second reflective device to compensate a phenomenon that a part of light beam from a monitored region is blocked by the first reflective device after the second reflective device is rotated.

26. The surveillance camera method as claimed in claim 20, wherein the optical imaging apparatus is switched between the first magnification level and the second magnification level in a fixed frequency, and the second reflective device is also rotated between two angles according to the fixed frequency, to obtain two sets of dynamic surveillance images.
